(19) United States
(12) Patent Application Publication
(10) Pub. No.: US 2017/0238562 A1
(43) Pub. Date: Aug. 24, 2017

(54) Novel Food Product and Method of Use

(71) Applicant: Peter Stuart Johnson, Glendowie, Auckland (NZ)

(72) Inventors: Peter Stuart Johnson, Auckland (NZ); Sung Je Lee, Auckland (NZ); Arwa Saleh D. Altalhi, Auckland (NZ)

(73) Assignee: Peter Stuart Johnson, Glendowie, Auckland (NZ)

(21) Appl. No.: 15/507,197

(22) PCT Filed: Aug. 27, 2015
(86) PCT No.: PCT/NZ2015/050122

§ 371 Date: Feb. 27, 2017

(30) Foreign Application Priority Data
Aug. 29, 2014 (NZ) 629773

(51) Int. Cl. A21D 13/50; A23P 30/40; A23L 15/00

(52) U.S. Cl. CPC A21D 13/50; A23L 15/20; A23P 30/40; A23V 2002/00

(57) ABSTRACT

The invention includes a composition when used for the subsequent preparation of an egg white foam, characterised in that the composition includes an amount of egg white material and at least one thickener. The amount of thickener(s) is at least about 2.0% w/w in the composition and the composition has been heat treated at or above about 40° C. prior to preparing the egg white foam. The invention also encompasses method of use, novel food products, cooked or uncooked, and methods of manufacture.

### TECHNICAL FIELD

The invention relates to a novel food product and method of use, and particularly is in relation to a foamable food product including egg white, and methods of manufacture and use.

### BACKGROUND ART

Egg white is a commonly utilised food material because of it is widely available and inexpensive to obtain, and has a good shelf life at room temperature in the unshelled egg form. Egg white can also be prepared and sold in a ready to purchase in a liquid form (EWL), conveniently separated from the egg yolk and shells. Egg white is also conveniently provided as a powder (EWP).

Additionally, egg whites have particularly beneficial nutritional qualities, being high in readily absorbable protein and essential amino acid content, and low in cholesterol, fats and sugar. For this reason, egg white based products have become a very popular nutritional supplement for sports athletes, amongst other nutritional uses.

Egg white is also well known as a foaming agent, and is commonly used as a foam base for many food products. It can be appreciated that raw, un-foamed egg white is not particularly appetizing for the large majority of consumers, and therefore has very little commercial application in this form. It is primarily the foamed egg white that has been, and will continue to be the focus for food technologists and manufacturers.

Although egg white is a very good foaming agent in general, there are many factors and considerations that alter the quality of the resulting foam. Significant research since the early 1980s has gone into the preparation of egg white foam and understanding the complexity of the science (both structure and function) behind it^{1,2,3,4}. For instance, it is well established that the primary determinant of egg white ¹ Kinsella, J. E. (1981). Functional properties of proteins: Possible relationships between structure and function in foams. Food Chemistry, 7(4), 273-288.² Damodaran, S., Anand, K., & Razumovsky, (1998). Competitive adsorption of egg white proteins at the air-water interface: direct evidence for electrostatic complex formation between lysozyme and other egg proteins at the Interface. Journal of Agricultural and Food Chemistry, 46(3), 872-876,³ Lomakina, K., & Mikova, K. (2006). A study of the factors affecting the foaming properties of egg white a review. Czech Journal of food Science, 24(3), 110-118⁴ Murray, 8, (2007). Stabilization of bubbles and foams. Current Opinion in Colloid & Interface Science, 12(4-5), 232-241. foamability is the egg white proteins, the most significant being ovomucin, ovomucoid, lysozyme and globulinss⁵.⁵ Damodaran, S., Anand, K., & Razumovsky, L. (1998). Competitive adsorption of egg white proteins at the air-water interface: direct evidence for electrostatic complex formation between lysozyme and other egg proteins at the interface. Journal of Agricultural and Food Chemistry, 46(3), 872-876.

Foam quality is generally measured with two criteria, namely “foamability” and “foam stability”⁶. Foamability is related to the volume of air that is incorporated into solution, and is generally measured by the total volume of the foam. Foam stability relates to the properties of interfacial films surrounding air bubbles, both in terms of their strength and viscoelastic properties⁷. Foam stability is normally assessed through both foam volume depletion vs. time, and secondly through rate of liquid drainage from the foam vs time. A common comparison measurement is the time taken for half of the foam mass to collapse (i.e. foam volume) and/or half of the foam liquid to drain (i.e. liquid drainage). ⁶ Lau, K., & Dickinson, E. (2004). Structural and theological properties of aerated high sugar systems containing egg albumen. Journal of Food Science, 69(5), E232-E239.⁷ Altalhi., 2013—unpublished embargoed Masters thesis, Massey University

There are three main methods to develop foamed egg whites; namely whipping, gas sparging and shaking.

Whipping is the most commonly used method. It relies on imparting mechanical forces on the egg white to produce foams that typically can last approximately one hour before the foam volume starts to subside. This can be enough time to then cook the foamed food product if required, allowing the foam structure to be maintained long term (e.g. in a Pavlova). The mechanical forces can be provided by hand using a whisk, or for instance by using an electric mix beater, blender or so forth.

Although the whipping method Is widely used, it can take significant time to produce the foam and therefore does not provide a convenient, ready to use egg white foam.

Also, the method can and often provides inconsistent results depending on a variety of factors. For example, the quality of the resulting foam (will be discussed shortly) will depend on the speed and/or time of agitation, the actual technique used, additional variables such as temperature/pressure, added ingredients in the product, and so forth. For example, although increasing the whipping time to a certain extent can impart greater foam qualities (e.g. foam stability), whipping the egg white for too long can deleteriously effect the quality.

Also, if the user is working directly from a whole egg, the inadvertent incorporation of even minute amounts of yolk will prevent the egg white from foaming all together.

Therefore, although the end results of the whipping method can sometimes be optimal, the method is generally inconvenient for a number of reasons discussed above.

Gas sparging is a much less commonly used technique to produce foamed egg white, and subsequent food products (Wang & Wang., 2009). Essentially, the method involves injecting the egg white solution with a gas such as nitrogen (N₂) under pressure (for instance in a sealed canister), and then the solution is released quickly through a nozzle in the canister, at which point the gas bubbles quickly expand to produce the egg white foam. Although this method provides an improved level of convenience (i.e. it is essentially immediate) and a high degree of reproducibility compared to the whipping method, it is not commonly used commercially because the resulting foam is very unstable. Typically, it immediately begins to lose its structure and volume, with almost complete loss of volume within 10-20 minutes. This limits its commercial use because the product does not hold its structure for either uncooked or cooked applications.

The third option is shaking in a sealed canister. This is similar to the mechanical action of whipping, but again has numerous disadvantages and inconveniences similar to the whipping method. Again, for obvious reasons, this method is not commonly used.

There has been much research into avenues to improve either the foamability and/or foam stability of egg white, and comparing the different techniques^{8,9,10}. Because of the complexity of the science and many variants involved, there has been a considerable amount of contradictions seen in the results, confusing best practices. ⁸ Bergquist, H. (Eds.). (2000). Eggs Kirk-Othmer Encyclopedia of Chemical Technology: John Wiley & Sons, Inc.⁹ Alleoni, A. (2006). Albumen protein and functional properties of gelation and foaming. Scientia Agricola, 63(3), 291-298.¹⁰ Wang, G., & Wang, T. (2009). Effects of yolk contamination, shearing, and heating on foaming properties of fresh egg white. Journal of Food Science, 74(2), C147-C156.

Additionally, many additives/techniques have been shown to provide minor improvements or alterations to the egg white foam quality.

For example, the concentration of protein is known to affect foam stability. Generally speaking, higher protein concentrations lower liquid drainage and reduce the surface tension in the solution to produce smaller bubbles (i.e. increasing foam stability). Yet, if protein concentration is too high, it can have an adverse effect on foamability (i.e. volume) thought to be because of the higher viscosity, slower rate of diffusion and unfolding of the protein at the air bubble Interfaces¹¹. Additionally, if the protein concentration is too high, it can adversely affect taste of the product. If certain proteins (e.g. ovalbumin) concentration is too low, for instance below 0.2% w/w it has been reported that the foam stability was reduced significantly (Rodriquez Patino et al., 1995). ¹¹ Lou, C., & Dickinson, E. (2005). Instability and structural change in an aerated system containing egg albumen and invert sugar. Food Hydrocolloids, 19(1), 111-121.

As noted above, whipping time can alter the foam quality, but this method is irrelevant to the gas sparging process.

Control of pH can have a small degree of effectiveness at improving foam stability. For instance, it has been observed that if the pH is maintained at approximately pH 4-5 (the pl of most egg white proteins), the foam stability is improved, thought to be because of an increased protein absorption at the air-water interface of air bubbles¹². ¹² Foegeding, E., Luck, P., & Davis, J. (2006). Factors determining the physical properties of protein foams. Food Hydrocolloids, 20(2-3), 284-292.

Some food grade hydrocolloids have been tested and shown to marginally improve foam stability over a short term (e.g. 1-10 minutes after foaming), thought to be because of Increased viscosity provided by the thickening effect provided by the hydrocolloid¹³. However, in another study, addition of hydrocolloid actually significantly decreased foamability compared to controls¹⁴. Therefore, although slight improvements in foam stability may have been observed with use of hydrocolloids, it appears to come at the expense of reduced foamability. ¹³ Mott, C., Hettiarachchy, N., & Qi, M. (1999), Effect of xanthan gum on enhancing the foaming properties of whey protein isolate. Journal of the American Oil Chemists' Society, 76(11), 1383-1386.¹⁴ Er [symbol] Elebi, E. A., & IbanoGLu, E. (2009). Effects of ionic strength on the foaming properties of whey protein isolate and egg white in the presence of polysaccharides, Journal of Food Processing and Preservation, 33(4), 513-526.

Raikos et al 2007 reported marginal improvement of foam stability by addition of 15% w/w sucrose to pre-heated egg samples, which the authors thought acted by increasing the liquid viscosity around bubbles, lowering the drainage rate. But the report also found that sucrose at 12% w/w or higher can inhibit foamability. This can be a problem especially if the intention is to develop a high foam volume product (for texture, mouth feel and appearance) with sucrose based flavourings.

Salt has also been reported to influence foaming properties of proteins, through protein coagulation. Yet, a problem is that salt can adversely affect taste, and if provided at the incorrect concentration can actually diminish foamability and stability.

The addition of metallic cations have also been reported to affect foamability of egg white up to 1 mM concentration.

Heat treatment is used to pre-pasteurize the egg white for food safety, typically at 58° C. for 3-4 minutes. If the temperature and/or time exceeds this protocol, there is substantial denaturation of the egg white proteins which has severe negative effects on foam stability and foamability. Therefore, the pasteurization must be kept below a certain temperature to allow downstream the base level and desirable foam characteristics. However, Patino et al 1995¹⁵ studied how pre-heat treatment of egg whites prior to gas sparging affected foam quality. It was found that only at the lower pre-treatment temperatures of between 5-20° C., the foam stability increased slightly. Also, if protein concentration and pre-heat temperatures were both increased, the results showed considerable foam instability. ¹⁵ Patino, J., Niño, R., & Álvarez Gómez, J. (1997). Interfacial and foaming characteristics of protein-lipid systems. Food Hydrocolloids, 11(1), 49-58.

As an alternative to heat treatment as a pre-pasteurization method, high pressure treatment has been used, and the effect of egg white foam has been analysed. The problem with this method is that it also causes protein denaturation. Indeed, in a study performed by Van der Plancken et al 2007¹⁶, high pressure pre-treatment significantly reduced the foam stability of egg white solutions. ¹⁶ Van der Plancken, I., Van Loey, A., & Hendrickx, M. E. (2007). Foaming properties of egg white proteins affected by heat or high pressure treatment. Journal of Food Engineering, 78(4), 1410-1426.

In summary, there has been many studies investigating ways to improve egg white foam properties (primarily foamability and foam stability), but each of the reported solutions comes with complexities and downfalls. Also the actual effectiveness can be quite minimal, and does not drastically improve the qualities of the foam observed from the gas sparging method in particular, which despite the convenience factors available, still suffers from considerable foam stability issues that are not addressed by the solutions discussed above.

Therefore, despite the difficulty, time delay and inconsistencies, the whipping method remains the mainstay for making egg white foam both in the commercial settings (e.g. restaurants, hotels, cafes, bakeries), and private use (e.g in the home kitchen).

Furthermore, there is also a long felt need to develop a composition and method that provides an egg white foam that:
can be used with a range of cooking/extrusion techniques to produce a wide variety of food products, yet still retain suitable foam characteristics and/or visual appearances (may depend on the application); and/or
can provide substantially immediate, and/or consistent egg white foam that displays good foam properties (foamability and/or foam stability); and/or
can be easily manipulated with a variety of flavourings and additives without having detrimental and/or unwanted effects on the foam properties, either with or without downstream cooking.

It is an object of the present invention to address the foregoing problems or at least to provide the public with a useful choice. It is a particular object to improve the effectiveness and usefulness of egg white foam produced by the gas sparging method.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or In any other country.

Unless the context clearly requires otherwise, throughout the description and the claims, the words “comprise”, “comprising”, and the like, are to be construed in an inclusive sense as opposed to an exclusive or exhaustive sense, that is to say, in the sense of “including, but not limited to”.

Further aspects and advantages of the present invention will become apparent from the ensuing description which is given by way of example only.

### DISCLOSURE OF THE INVENTION

According to one aspect of the present invention there is provided a composition when used for the subsequent preparation of an egg white foam, characterised in that the composition includes:
a) an amount of egg white material
b) at least one thickener, wherein the amount of thickener(s) is at least about 2.0% w/w in the composition;
   and wherein the composition has been heat treated at or above about 40° C. prior to preparing the egg white foam.

According to a further aspect of the present invention there is provided a egg white foam characterised In that the egg white foam includes:
a) an amount of egg white material
b) at least one thickener, wherein the amount of thickener(s) is at least about 2.0% w/w in the composition;
   and wherein at least the egg white material and at least one thickener had been heat treated together at or above about 40° C. prior to forming the egg white foam.

According to a further aspect of the present invention there is provided a method of preparing a foamed egg white or foamed egg white based food product

characterised by the step of aerating the composition as described herein to form an foamed egg white or foamed egg white based food product.

For instance, the aeration may be from gas sparging, whipping or a shaking method.

According to a further aspect of the present invention there is provided a food product including a foamed egg white substantially as described herein.

According to a further aspect of the present invention there is provided a kitset, wherein the kitset including:
a) the composition as described herein;
b) a gas sparging device suitable to retain the composition prior to delivery, and subsequently administer the composition through an aperture to produce the egg white foam.

The Applicant has identified a highly beneficial and synergistic effect seen from the claimed invention in that it leads to a substantial, unexpected improvement at least with regards to egg white foam stability, and also may help to open a wide range of downstream food applications as will be discussed in further. Other aspects of the invention will be elaborated on below.

Although the Applicant sees the commercial uses of this invention to be particularly applicable to the gas sparging method (which has good foamability, but suffers from foam instability compared to the whipping method), there is no reason why the invention described herein could not be used to develop egg white foams with other methods, such as the whipping and/or shaking methods as will be discussed in more detail below. However, for brevity, the majority of this specification will describe the composition and its uses particularly in the context of using the gas sparging method.

### Definitions and Preferred Embodiments

Throughout this specification the term egg white or egg white material should be taken as meaning substantially all of, or an extract of, the largest component of eggs other than the egg yolk (the yellow sac portion) and outer hard shell. A typical egg white, also referred to commonly as albumen, contains about 90% water, 10% protein, less than 1% carbohydrate (e.g. glucose) and 0.5% ash, and less than about 0.01% lipids^{17,18}). There are also a wide variety of minor nutrients in egg white, as detailed in Huopalahti et al 2007. ¹⁷ Hui, Y. H., & Al-Holy, M. A. (Eds.). (2007). Food chemistry: Principles and Applications (2nd ed.). West Sacramento, Calif.: Science Technology System.¹⁸ Huopalahti, R., Lopez-Fandino, R., Anton, M., & Schade, R. (Ed.). (2007). Bioactive Egg Compounds. Berlin London: Springer.

It should be appreciated that the egg white material may be from egg white liquid (EWL) and/or egg white powder (EWP), the latter which is subsequently reconstituted prior to use for foaming methods. In preliminary trials, the EWL showed an improved overall appearance (smooth, silky and creamy) compared to the trails with EWP.

Throughout this specification the term egg white foam should be taken as meaning an aerated, bubble containing or gas induced foamy material using egg white as a base ingredient, together with any number or combination of additional excipients, flavourings, and/or ingredients.

### Thickener

Throughout this specification the term thickener should be taken as meaning any naturally available, Isolated, or synthetically derived food grade material which acts to increase the viscosity of the composition and/or acts as a hydrocolloid. There is a wide variety of thickeners commercially used and available, and it is envisaged that substantially any or all (either available now or in the future) of these are applicable and should work according to the present invention. After understanding the concept of the present invention, it would be routine workshop variation to test thickeners to observe if the results expected particularly with regards to foam stability, are seen. A number of thickeners are exemplified in this specification to illustrate this point, but the invention should not be limited to such examples.

Preferably, the thickener is selected from the group consisting of a starch, a vegetable gum and pectin, or any combinations thereof.

Preferably, a starch thickener is selected from the group consisting of fecula, arrowroot, rootstarch, cornstarch, katakuri starch, potato starch, sago, tapioca flour or any combinations or derivatives thereof.

Preferably, a vegetable gum thickener is selected from the group consisting of alginin, guar gum, locust bean gum, gum arabic and xanthan gum, or any combinations or derivatives thereof. Such vegetable gum may be provided by a variety of sources, although commonly are extracted from plants and seaweeds or produced by microbial synthesis. Some thickeners are often referred to as hydrocolloids.

The Applicant is aware based on the literature (e.g. Mott et al., 1999¹⁹) that some hydrocolloid thickeners can improve egg white foam stability for the short term (1-10 minutes after foaming). This is consistent with trials conducted by the Applicant wherein addition of various thickeners alone did marginally improve egg white foam stability over a 1-10 minute time frame. Yet foam volume/liquid drainage measurements then began to sharply deteriorate about 10 minutes, and by 30 minutes showed no difference to the negative positive control egg white samples, where both foam volume and liquid drainage were essentially reduced close to the 0% base line. This is not ideal, and still does not address the underlying issue with gas sparged egg white foam instability compared to the more stable whipping method. ¹⁹ Mott, C., Hettiarachchy, N., & Qi, M. (1999). Effect of xanthan gum on enhancing the foaming properties of whey protein isolate. Journal of the American Oil Chemists' Society, 76(11), 1383-1386.

Whereas, the Applicant then conducted further trials and saw an unexpected and quite a spectacular phenomenon. When the egg white was combined with the thickener as a composition, and then the composition being pre-heat treated prior to developing the foam, significant and unexpected results were seen. Specifically, the Applicant observed the following advantages:
the resulting foam showed exceptionally improved foam stability compared to the heat treated samples (without thickener) and compared to samples containing thickener (without pre-heat treatment). Both foam volume and foam liquid measurements were substantially improved in preliminary trials, and was encroaching on the beneficial stability seen with whipped egg white foam.
For example, the egg white+thickener sample heated to 63° C. prior to foaming showed about 75% foam volume and 55% foam liquid after 30 minutes. Oppositely, samples with thickeners (yet no pre-heating) showed about 10% foam volume and 10% foam liquid at the 30 minute time point. Similarly, all the egg white foams that were pre-heat treated between 20 to 63° C. (yet without a thickener) showed about 10% foam volume and essentially 0% foam liquid at the 30 minute time point. Therefore, there is clearly a substantial and unexpected synergistic effect occurring between the thickener, egg white material and the pre-heat treatment.
The resulting foam and/or cooked foam showed excellent visual appearance compared to samples without thickener and/or pre-heat treatment.
As the pre-heat temperature increased from 20° C. to 63° C., the foam stability measurements unexpectantly improved quite significantly, particularly at the higher temperatures. This is completely contrary to what is taught by the prior art, where foam stability is negatively affected by pre-heat treatment above 20° C. Furthermore, visual appearance of the foams were not negatively affected by the heat treatment when thickeners were present.
Unlike what Is taught in the prior art, the higher temperatures such as 63° C. do not adversely affect foamability when the thickener is present. Therefore, both good foamability and foam stability are unexpectantly achieved. This is a considerable benefit, as many approaches trialed may have some minor improvement in say foam stability over the short term, but then equally negatively affects the foamability. Not only does the present invention achieve beneficial levels of both measurements, but it does so exceptionally well.
Additionally, the thickener is also providing a beneficial effect by protecting the egg white protein from denaturation during the pasteurization process, normally conducted at 58° C. for 3-4 minutes. As such, it is possible to speed up the pasteurization process because higher temperatures such as 63° C. can be conveniently used for shorter time frames, whilst also observing the beneficial effects with foam quality at higher temperatures as noted above.
in preliminary trials, the synergistic effect observed does not appear to be affected substantially by altering or adding additional excipients such as sugars, flavourings, and so forth.

In informal trials using less than about 2.0% w/w thickener, the beneficial foam stability effects were much less apparent, or not present at all at very low levels of thickener (e.g. below 0.5% w/w). The trials performed by the inventor show that with over 2% w/w thickener present, very pronounced stability effects are observed, but these effects are critically linked also to the pre-heat step of the composition required by the invention. For example, a composition with 0.04% xanthan gum, 0.04% gaur gum, 0.04% locust bean gum and 2% gum Arabic (totaling 2.12% w/w thickeners, as shown in Example 8) which was then pre-heated before subsequently foaming the composition showed exceptional and unexpected foam stability.

When compared to other compositions previously used, the present invention (with over 2% w/w thickener) leads to a foamed egg white with remarkably improved stability and superior foam qualities over 30-50 minutes which can be achieved by convenient gas sparging, compared to other foams are made by conventional whipping, and/or suffer from significantly reduced stability.

Generally, the Applicant observed that increasing the amount of thickener used beyond 2% w/w, the greater the foam stability and synergistic effect seen. However, it was seen that if the amount of thickeners is increased too much, the concentration of the foam forming elements in the egg white (i.e. the proteins) may be reduced somewhat, which could impact overall foam characteristics. However, one option to circumvent this (if required) is to simply to add EWP to the EWL to increase the protein concentration whilst also achieving higher levels of thickener as required. Additionally, it was seen that foamability was not reduced or improved based on the amount of thickeners added. On this basis, there is no apparent definite upper limit of thickener which forms part of the invention.

More preferably the composition includes at least two thickeners.

In preliminary trials increasing the number of thickeners in the composition tended to improve foam stability. However, satisfactory results were observed just using 2% w/w of a single thickener (results not shown).

### Heat Treatment

To overcome contamination of egg white, it is standard practice to pasteurize the material using heat pasteurization, or in some cases the combination of high hydrostatic pressure processing (HHP) and temperature (perhaps at a lower temperature, yet still effectively is heat pasteurization). The pressure from HPP improves the effectiveness of the inactivation of microorganisms at a temperature. There are also various alternatives to heat pasteurization, including pulsed electric field (PEF), UV radiation, ultrasonic treatment, and ionizing radiation treatment. Such techniques can significantly improve shelf life. It should be appreciated that such pasteurization techniques may be applied to either the composition at any stage prior to foaming, or even to the resulting product prior for sterilization for storage (for instance UV radiation of a cooked foam as an alternative to tofu—see further below).

It should be appreciated that the term heat treated or heat treatment should be taken as meaning any incubating, storing or otherwise bringing the temperature of the composition to above about 4° C. (standard refrigeration storage conditions of egg white) for a pre-determined length of time (with or without HPP treatment) prior to producing the egg white foam. It should be appreciated that the term heat treatment does not necessarily need to be sufficient to act as a pasteurization step to sterilize the composition, but most preferably it does. Doing so helps to achieve at least two different issues, both pre-pasteurization (for food safety) and improving the downstream stability of the egg white foam.

Preferably, prior to use, the composition has been heat-treated between 15° C. to 75° C.

More preferably, the composition has been heat treated between 50° C. to 70° C.

Most preferably, the composition has been heat treated at about 63° C.

It was unexpectantly found that the thickeners seemed to protect the egg white protein from denaturing when incubated/pasteurized the higher temperatures above 58° C. This effect may very advantageous because it should allow a faster (and/or improved) pasteurization step at higher temperature (for instance 2 minutes instead of 4 minutes). Shelf life trials showed that the higher temperature treatment at 60° C. for 2 minutes showed shelf life stability of the composition (without microbial contamination) for 4° C. for 8 weeks.

The high temperature pre-treatment also is seen to significantly improve foam stability, and without causing a significant negative effect on foamability. This is completely contrary to the prior art findings, as well as the Applicant's own studies with heat treatment of pure egg white.

Preferably, the composition is heat treated for between 10 seconds to 10 minutes.

More preferably, the composition is heat treated for about 2 minutes.

A test with a two minute incubation at about 63° C. showed very beneficial results, and it is quite possible that varying the temperature/time will show even greater effects. Similarly, it may allow one to control the foamability or foam stability as so desired.

### Protein

Throughout this specification the term protein should be taken as meaning any amino acid chain, or polypeptide molecule in any form that is made from, extracted from, genetically manipulated or artificially produced from a naturally occurring biological material, or is synthetically manufactured.

Proteins are an integral component of the egg white system that provides the foaming characteristics.

Preferably, the composition includes at least 5% w/w protein.

More preferably, the composition includes between 5% w/w to 20% w/w protein.

Most preferably, the composition includes about 8-12% w/w protein.

Pure egg whites naturally have approximately 10% w/w protein, leading to good foamability (and foam stability when using the whipping method). However, when other ingredients or excipients are added to the composition (for instance thickener(s)), the relative concentration of protein in the composition decreases, and foamability/stability tends to suffer.

Additionally, the Applicant observed that when sucrose was added to pure egg white in concentrations higher than about 10% (for example 18% w/w), the resulting foam stability decreased substantially. Yet, as protein concentration in the egg white was increased from about 10% to 18% (by adding EWP), the foam stability increased in a linear fashion. Therefore, in the presence of high sugar concentration (which is often preferred for taste and/or providing a glossy appearance to the foam), protection from severe foam instability may be provided by increasing protein concentration. Yet, this becomes problematic because of negative taste issues and sensory mouth feel, as well as possible negative effects with foam stability, from a high protein concentration in the foam.

It became evident that the present invention helps to address this conundrum. In compositions with egg white, thickener, 20% w/w sucrose and with pre-heat treatment (with no added protein, therefore about 9% w/w protein), the resulting foamability, and more importantly, foam stability was not negatively affected by a high sucrose content.

### Sugar

As noted above, sugar is often a desired ingredient in egg white foams, to improve taste as well as sensory mouth feel and appearance (it provides a smooth glossy appearance to the foam). Yet, it can negatively affect foam stability. The present invention helps to address this issue without having to revert to high protein concentrations. Instead, protein levels may be retained at an optimal level, and the improved stability may be retained whilst still being able to use high levels of sucrose.

The same results are expected to be seen with other sugar types and or flavourings.

Preferably, the concentration of sugar is in the range of 2-30% w/v, or sometimes even higher. However, it is clear the present invention allows one to adjust this concentration without the impact seen with sucrose on pure egg white.

pH

It is known that adjusting the pH of egg white to its pl (pH 4-5) improves foam stability substantially²⁰. ²⁰ Bov\check{s}ková, H., & Miková K. (2011). Factors Influencing egg white foam quality. Czech Journal of Food Sciences, 29(4), 322-327.

Preferably, the pH of the composition is between 6-10.

More preferably, the pH of the composition is between 8-9.

The Applicant identified that the present invention provides improved foam stability, whilst being able to retain the normal pH of egg white (about pH 8.6) in the composition and resulting foams. Therefore, good foam stability could be provided without having to decrease the pH of the composition just prior to foaming to near acidic levels of pH 4-5, as seen in the prior art. Such acidity may negatively affect other aspects of the composition, such as taste. Also, storing an egg white based composition according to the present invention at pH 4-5 would almost certainly lead to low shelf life, due to denaturation of the proteins.

Any such commonly known or used pH modifier may be used (if necessary), and citric acid is given as one example in this application. The invention should in no way be limited to such, and it would require only common workshop variation and trials to exchange citric acid for a suitable alternative pH modifier.

### Other Additives

One of the advantages of the composition of the present invention is that it provides a base to which different ingredients, additives and so forth can be added, with or without subsequent downstream cooking of the resulting foam. In preliminary trials (not shown), the good foamability and foam stability appear to be retained despite substantial manipulation of the composition's contents.

The types of additives that may be used in the present invention include metal cations, salts, jams, chocolate, flavourings, ground or freeze dried food material (for instance freeze dried shrimp), spices, herbs, and so forth. It is possible that some of these additives may also act beneficially as the thickener, and provide the advantages according to the present invention. The versatility of this composition and egg white foam produced will become more apparent in the next section which elaborates on preferred methods of use.

### Method of Preparing a Foamed Egg White and Optional Downstream Cooking

As discussed previously, the invention is particularly applicable to the gas sparging method of preparing egg white foam. This conventional, yet unpopular method is particularly convenient and reproducible compared to the whipping method, but unfortunately suffers because of the significant issues with foam stability which has led to a substantial amount of R&D and corresponding literature attempting to remedy this problem.

As previously discussed, the gas sparging method should be taken as meaning any method which involves retaining the egg white solution under pressure (for instance in a sealed canister) with a gas such as nitrogen (N₂), carbon dioxide (CO₂) or even atmospheric oxygen, and then the solution is released quickly through a nozzle in the canister, at which point the gas bubbles quickly expand to produce the egg white foam. A wide variety of options are available through this method, for instance by using a small aerosol can (for convenient long term storage and subsequent use), or in a large scale processing tank to produce products on a commercial scale (e.g. high throughput extrusion technology).

The present invention overcomes this significant hurdle seen in the industry, and therefore may lead to the gas sparging becoming a much more widely and commercially used method. Equally, it opens up many opportunities to make egg white foam easily, substantially instantaneously, reproducibly, and without hassles or physical mechanical energy required by a person (i.e. whipping or shaking).

Preferably, the method of preparing the foam includes using the gas sparging method.

For example, a re-usable whipping cream canister which can be charged with a N₂ gas canister, to which the composition is added when required, prior to use by spraying the foam out via the nozzle on the canister.

In one embodiment, the method does not include cooking the egg white foam.

For example, a pre-prepared aerosol can with the composition already provided within it (stored under gas pressure) may be commercially useful. In one embodiment, the Applicant envisages this approach may allow the foam to be made as a ready to consume nutritional/protein supplement, for instance for athletes. In this embodiment, the nozzle may be adapted to include a user friendly mouth-piece to allow a user to apply it directly to the mouth for consumption. Consuming liquid egg white (albeit pasteurized) is not particularly desirable, but converting it instantaneously to a foam on demand overcomes this unpalatable association with raw egg.

In a similar sense, the Applicant sees that foam produced by the present invention may be commercially used a stable dairy-free base for products like thick-shakes, smoothie bases, protein based shakes, yogurts, mousses, sorbets, and the like. Conveniently, such products do not typically require cooking of the egg white foam, so the ability to provide a stable, easy and quick source of egg white foam is commercially very useful.

Alternatively, the egg white foam produced by the method is cooked.

In preliminary trials, the synergistic effect regarding foam stability observed does not appear to be negatively affected, comparatively, by downstream cooking processes of the egg white foam. Quite the opposite, in preliminary trials foamability is substantially improved, and the relative foam volume overall vs time improved. Additionally, the thickeners and/or pre-heat treatment also provides considerably better visual appearance to the cooked product compared to the cooked product without thickeners and/or heat treatment.

Regarding cooked products, one can easily see the immediate commercial opportunities such as a commercial kitchen or household utilising a ready to use “pavlova in a can” product which can be immediately sprayed onto a baking tray in a desirable shaped foam, and then baked in the oven.

As another example, a “meringue-in-a-can” product can be easily envisaged. The present invention overcomes the foam stability issues seen with gas sparging, and avoids the requirement to using whipping as the mainstay of developing such food products.

Another commercially viable option is high throughput extrusion cooking, whereby the foamed egg white is transferred through a cooking process, before being extrusion cut to prepare products like a tofu alternative, a dairy free alternative to a yogurt or mousse style snack (typically stored in a plastic container), and so forth.

Another feasible alternative Is frying the egg white foam on a frying pan to prepare an omelet style meal. The user could easily add his/her own flavourings or ingredients to the top of the foam, such as slices ham, mushrooms etc, before flipping on the pan for further cooking.

Preferably, the egg white foam is cooked by microwave cooking.

In one example, the egg white foam may be microwaved for about 10 to 40 seconds at 1000 W in a 25.5 litre capacity (or equivalent conditions).

The Applicant has trialed microwaving cooking, and has shown that by varying the time and intensity of cooking, different results may be achieved with the resulting cooked product. A variety of cooking techniques may be applied, including microwaving, frying, baking, deep-frying, extrusion cooking, poaching and so forth.

After microwaving, the Applicant saw remarkable increases in foamability beyond the initial foaming seen after the gas sparging methods.

As discussed previously, if the gas sparging method is used to prepare egg white foam simply from pure egg white, the Applicant's studies showed the cooked foam quickly loses its stability after about two minutes, and essentially collapses.

The Applicant identified that cooking the egg white foam by microwave (as an example) using the composition according to the present invention, it resulted in further beneficial results with regards to initial foam volume, and foam volume and liquid drainage over time.

Overall, as shown in the results, the inclusion of the thickener(s) in the pre-heated composition led to the following beneficial and commercially important characteristics in cooked products (compared to either just pure egg whites treated in the same fashion, or compared to whipped egg whites that are subsequently cooked):
good overall appearance (glossy, thick and creamy);
good foamability;
good relative foam volume over time; and/or
good liquid retention over time.

In a further aspect of the present invention there is provided a method of preparing a cooked food product including an egg white foam, characterised by the steps of:
a) inserting an amount of egg white material into a substantially sealable canister
b) pressurizing the canister by incorporating a gas
c) releasing at least a portion of the egg white through an aperture in the canister to produce a foamed egg white; and
d) cooking the egg white material.

In a further aspect of the present invention there is provide a food product characterised in that the food product includes egg white material in an aerosol can or container. Throughout this specification the term aerosol is a mixture of particles or liquid droplets in air or another gas.

In a further aspect of the present invention there is provided an egg white based foam produced from egg white material stored in an aerosol can or container, and then subsequently purged through an aperture to produce the egg white foam.

The Applicant's research has found that there is no prior teaching of using a gas charged (ie. aerosol) canister to produce egg white foam, which is then used in an uncooked format, or subsequently cooked to form a cooked food product. It should be appreciated that the method most preferably utilises the composition of the present Invention, as significantly improved results are seen. However, the method may simply use pure egg white or egg white with other excipients/treatments as described in this specification besides the composition as described having a thickener and is pre-heated.

Finally, it should be appreciated that the composition may be stored prior to carrying out the foaming method in a variety of containers, and need not be a pre-charged aerosol can, despite this being a preferred embodiment for convenience. Similarly, the end product, be it the egg white foam, or the cooked egg white foam (or a product containing either) may be stored in a wide variety of container types.

The present invention provides at least one of the following advantages
providing a convenient, reproducible and/or substantially instantaneous method for foaming egg white compared to the whipping method, and one which provides improved foamability and/or foam stability characteristics (compared to control gas sparged pure egg whites) using the composition and methods as described;
providing a composition that can be pasteurized at higher temperatures/lower time frames than currently available, whilst also “charging” the composition at the same time to produce remarkably improved foam characteristics.
providing a closely comparable egg white foam (e.g. foam stability and foamability) to the whipping method, yet using the gas sparging method;
improvements in sensory characteristics and/or stability of subsequently cooked egg white foams;
providing a wide variety of commercial opportunities for both uncooked and cooked egg white foam based products.

### BRIEF DESCRIPTION OF THE DRAWINGS

Further aspects of the present invention will become apparent from the ensuing description which is given by way of example only and with reference to the accompanying drawings in which:

FIG. 1 Effect of whipping time on foamability of egg white liquid prepared using a standard mixer;

FIG. 2 Stability of (A) foam volume and (B) foam liquid from foams produced by whipping method at different times,

FIG. 3 The volume of foams produced by a gas sparging method (whipped cream dispenser) after shaking EWP solution for different times

FIG. 4 Stability of EWP foams produced by a gas sparging method after shaking for different times (0-50 times); (A) foam volume stability and (B) foam liquid stability

FIG. 5 Changes to stability of foam volume (A, B, C and D) and foam liquid (E, F, G and H) over time after foam preparation. Foams were prepared by gas sparging in a whipped cream dispenser after shaking different volumes of EWP solution, for different times (10-50 times).

FIG. 6a Appearance of foams prepared from (A) 50 ml of egg white liquid (EWL) and (B) 50 ml of egg white powder (EWP) solution by gas sparging using a whipped cream dispenser after shaking for 20 times.

FIG. 6b Foamability of EWL and EWP solutions produced by gas sparging using whipped cream dispenser.

FIG. 7 Stability of foams prepared with EWL and EWP solutions after shaking for 20 times with 50 ml solution; (A) foam volume stability and (B) foam liquid stability.

FIG. 8 Effects of concentrations of sucrose and protein on (A) foamability, (B) foam volume stability and (C) foam liquid stability of foams produced from 100 ml of egg white powder (EWP) solutions after shaking 20 times.

FIG. 9 Foamability of EWP solutions (10% protein; 4 and 20° C.) prepared from EWP with three different types of thickeners at different concentrations.

FIG. 10 Stability of foam volume and foam liquid of egg white foams prepared, at two different temperatures, from solutions of egg white powder mixed with thickeners at different concentrations.

FIG. 11 Pictures of egg white liquid (EWL) containing 10% protein after heat treatment at different temperatures; (A) 58° C. for 3.5 min, (B) 60° C. for 2 min and (C) 63° C. for 2 min.

FIG. 12 Foamability and foam stability of foams produced from EWL solutions after heat treatment at 20, 58, 60 and 63° C. which were shaken for 20 times; (A) foamability, (B) foam volume stability and (C) foam liquid stability.

FIG. 13 Images of EWL samples taken 1 hr after heat treatment at 58° C. for 3.5 min (A and D), 60° C. for 2 min (B and E) and 63° C. for 2 min (C and F) In the absence (A, B and C) and presence of ingredient mixture (sucrose, thickener, citric acid) (D, E and F).

FIG. 14 Effect of heat-treatment of EWL containing ingredients (sucrose, thickener, citric acid) at different temperatures (20, 58, 60 and 63° C.) on (A) foamability, (B) foam volume stability and (C) foam liquid stability.

FIG. 15 Foam stability of egg whites with and without added ingredients. The egg white solutions mixed with ingredients were heat-treated at different temperatures (20, 58, 60 and 63° C.) prior to foaming. Foam volume stability (A, B, C and D) and foam liquid stability (E, F, G and H).

FIG. 16 Effect of microwave cooking on the foam volume of egg white foam produced from EWL as a function of cooking times (10, 20, 30 and 40 s).

FIG. 17 Effect of microwave cooking on the foam stability of egg white foam produced from EWL as a function of cooking times (10, 20, 30 and 40 s); (A) foam volume stability and (B) foam liquid stability.

FIG. 18 Effect of heat treatment of EWL solution at 20, 58, 60 and 63° C., prior to making foam on the foam volume (A), foam volume stability (B) and foam liquid stability (C) of foams after cooking in the microwave for 30 s.

FIG. 19 Pictures of foams prepared from EWP solutions mixed with three different types of thickeners at different combinations and concentrations.

FIG. 20 Foam appearance after cooking in the microwave oven for different times (10, 20, 30 and 40 s). Egg white foams prepared from EWP solutions containing 10% protein (A, B, C and D) and 20% protein (E, F, G and H).

### BEST MODES FOR CARRYING OUT THE INVENTION

### Example 1: Analysis of Foamability and Foam Stability of Pure Egg White Foam—Using Whipping Method

### Methodology:

Frozen pasteurised egg white liquid (EWL) (10% w/v protein), and egg white powder (EWP) (99.4% protein in dry base) were purchased from Eggcel (Eggcel, New Zealand) and used for all experiments herein unless stated otherwise.

Egg white foam was prepared using a standard kitchen mix beater, which was a standard mixer with two stainless steel beaters (5 speed control) (Breville Wizz Mix EM3, New Zealand).

### Results and Discussion:

i) Foamability

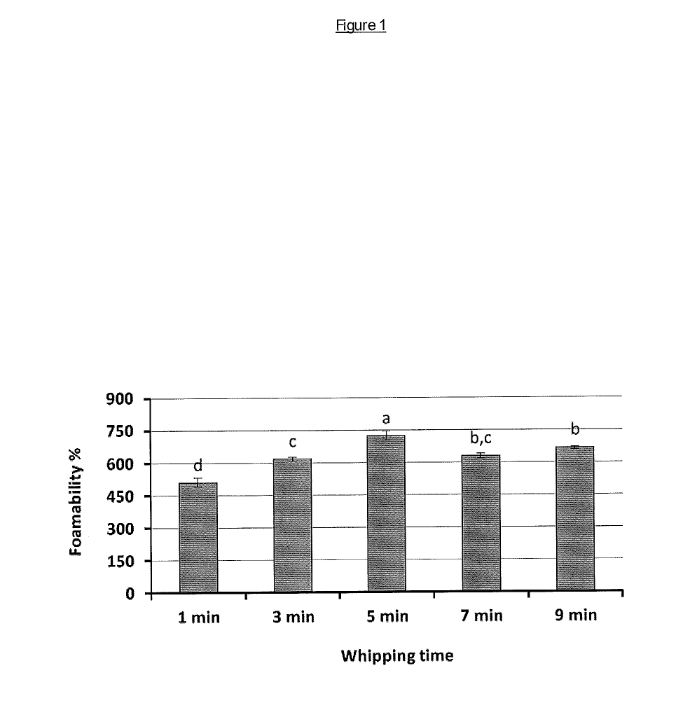

As shown in FIG. 1, foamability results varied widely depending on the whipping time, illustrating the inconsistencies seen with this method. At best, foamability was recorded at about 730% (5 minutes whipping time).

ii) Foam Stability

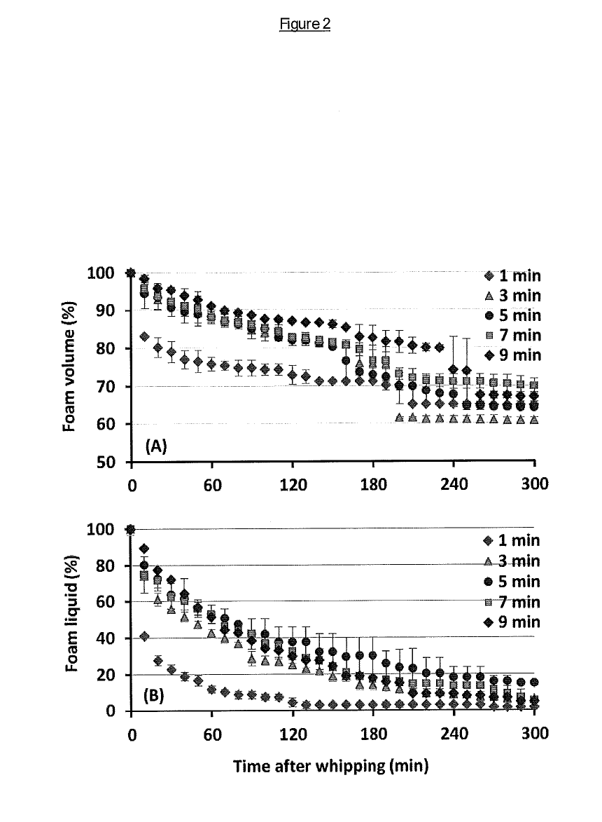

As shown in FIG. 2 foam stability shows overall fairly good results, although the results vary significantly with the whipping time, again leading to problematic inconsistencies with this method. Although longer whipping times led to increased foam volume stability, foam liquid stability was dramatically lost with higher whipping times—this is again problematic. At best, foam volume showed about 50% reduction after about 300 minutes (whipping time of 9 minutes). Similarly, at best there was a 50% loss of foam liquid after about 120 minutes (whipping time of 5 minutes). Despite the inconsistencies and inconvenience of the whipping method, the overall stability results are the reason why the whipping method has been the mainstay of producing egg white foam.

### Example 2: Analysis of Foamability and Foam Stability of Pure Egg White Foam—Using Gas Sparging Method

### Methodology:

In this study, egg white foams were prepared from EWL or EWP solutions using a whipped cream dispenser (0.5 litres size) with a nitrous oxide (NO₂) gas charger (8 g pure NO2 per charger) (Mosa cream whipper, Mosa Industrial Corp., Yunlin, Taiwan). According to the manufacturer's guidelines, one charger can whips up to 0.5 litre of solution (e.g. whipping cream, desserts, mousses, sauces, etc).

Briefly, an aliquot amount of EWL or EWP solutions (50 g unless otherwise stated) was poured into the whipped cream canister. The canister was tightly closed with a top head which had a metal nozzle part (attachable with a decorator tip), a lever arm and a metal holder (to be attached with a gas charger cylinder holder).

After inserting the NO₂ gas charger into its cylinder holder, the cylinder holder was attached to the metal holder on the canister head and twisted clockwise until it was locked into position. Upon placed into a lock position, the NO₂ gas was released into the canister containing the egg white solution. The canister was then shaken up for 20 times (unless otherwise stated) to enhance the sparged gas to be uniformly transferred into and absorbed by the egg white solution, thus generating gas pressure inside the canister. The dispenser was hold upside down pointing the nozzle tip down and triggered to release the foam from the canister into a glass beaker (250 ml) by pressing the lever. This methodology for gas sparging was used for all gas sparging trials below, unless stated otherwise.

The resulting foams were then analysed immediately for foamability and foam stability.

### Results and Discussion:

i) Foamability

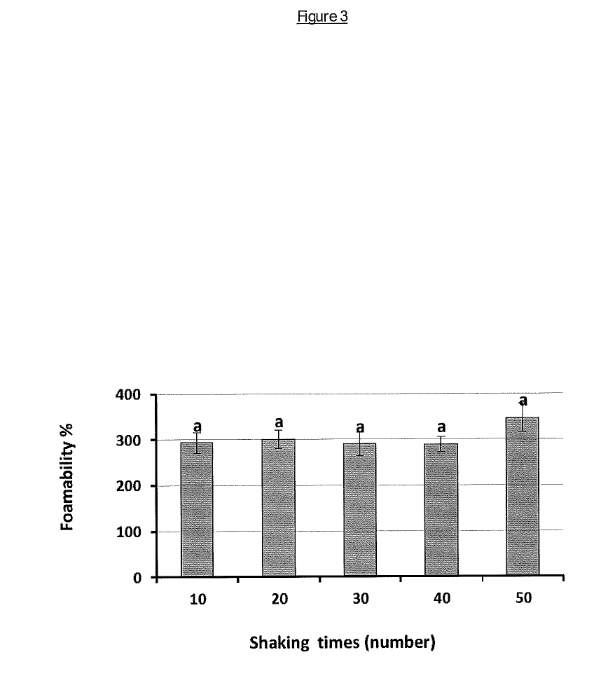

As shown in FIG. 3, foamability results were fairly consistent, despite varying the number of initial shakes (simply to help mix the gas within the canister). It is clear that shaking has no real effect on the results. Foamability was consistently at about 300%, so quite a bit less than the foamability seen with the whipping method.

ii) Foam stability

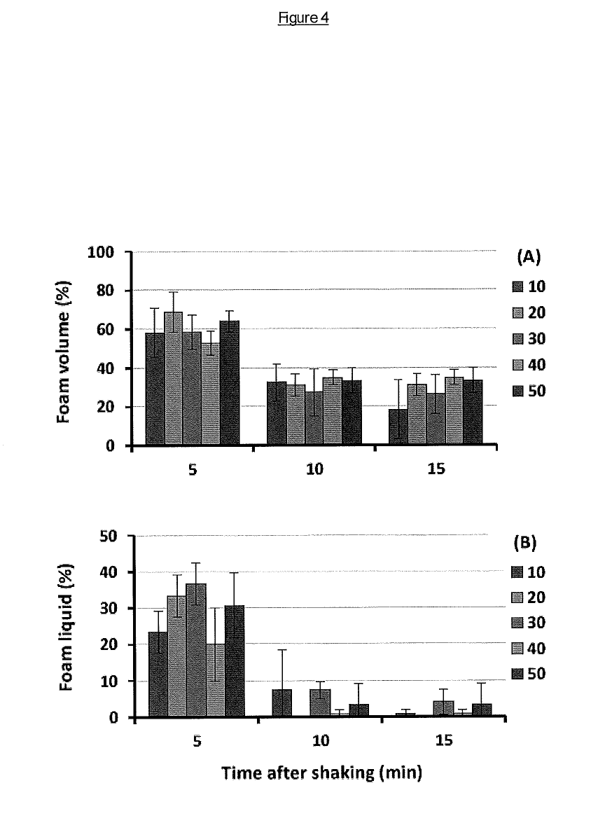

As shown in FIG. 4, foam stability was poor. Foam volume decreased to about 30% within 15 minutes. Foam liquid decreased to about 5% or less within the same 15 minutes. This Illustrates why gas sparging has not been a popular method compared to whipping, despite the initial advantages of convenience, consistency and speed.

### Example 3: Effect of Volume of EWL with Gas Sparging

### Methodology:

Different amounts of EWL were added to the canister to see if volume to gas ratio made a difference to the foam characteristics.

### Results and Discussion:

i) Foamability

As shown in Table 1 below, foamability increased marginally with greater volumes of EWL as expected.

| EWP | | | | | |
|---|---|---|---|---|---|
| volume | Number of Shakes | | | | |
| (ml) | 10 | 20 | 30 | 40 | 50 |
| 50 | 293 ± 23^{c} | 301 ± 20^{b} | 290 ± 27^{b} | 289 ± 17^{c} | 347 ± 31^{a} |
| 100 | 337 ± 6^{b} | 327 ± 6^{b} | 322 ± 13^{b} | 323 ± 13^{b} | 325 ± 22^{a} |
| 200 | 355 ± 9^{ab} | 326 ± 25^{b} | 278 ± 26^{b} | 257 ± 3^{d} | 307 ± 8^{a} |
| 400 | 371 ± 4^{a} | 399 ± 13^{a} | 413 ± 10^{a} | 420 ± 13^{a} | 368 ± 46^{a} |
| p | <0.05 | 0.001 | <0.05 | <0.05 | 0.148 |

Results are expressed as the mean ± SD for three replications
^{a-d}Means followed by the same letter within a column are not significantly different (p < 0.05), p values indicate the significant variance between samples with no significant difference at p < 0.05.

Altalhi., 2013—unpublished embargoed Masters thesis

ii) Foam Stability

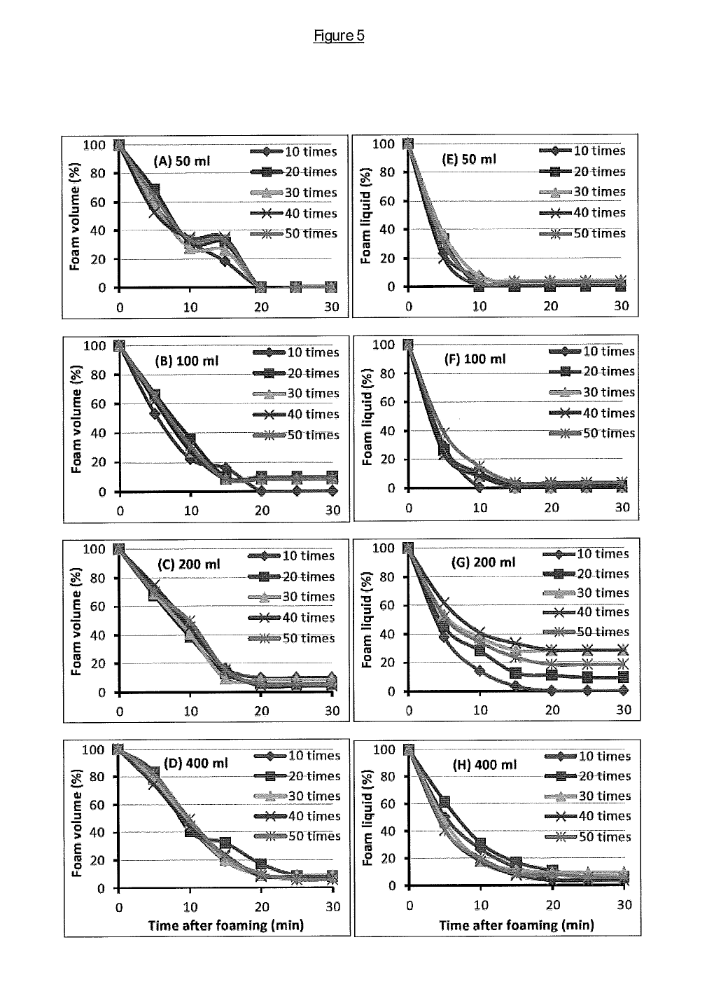

As shown in FIG. 5, foam volume stability was consistently poor regardless of the amount of EWL added. Interestingly, foam liquid stability increased considerably if 200 ml EWL was used in combination with increased amounts of shaking. However, this result was not seen with 400 ml EWL.

### Example 4: Effect of Using EWP Vs EWL with Gas Sparging

### Methodology:

In this experiment, a 50 ml of EWL and EWP solutions both containing 10% wt proteins at 20° C. were used, and both were shaken 20 times for the gas sparging method.

### Results and Discussion:

i) Foamability

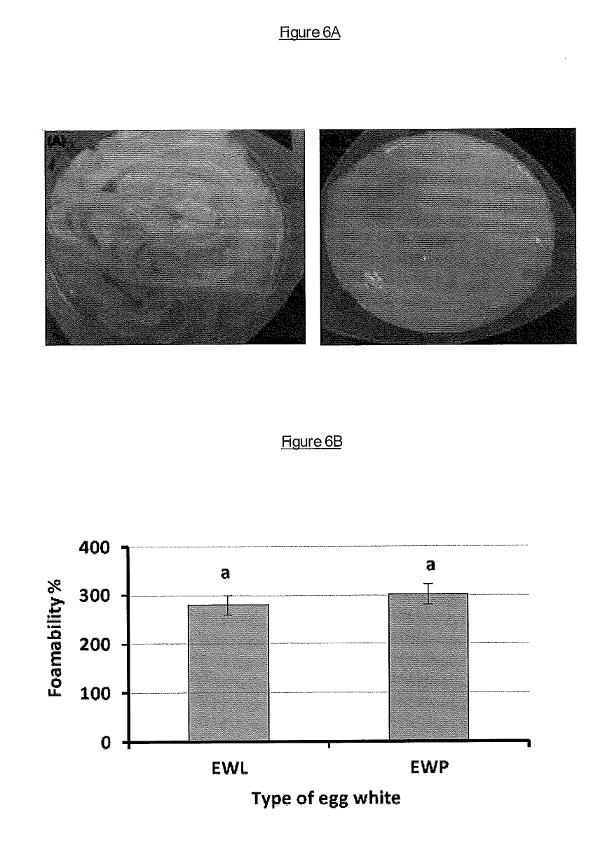

As shown in FIG. 6a, the appearance of the foam between the EWL and EWP were very different. The EWL produced a thick and creamy foam, whereas the EWP solution produced a liquid-like foam. As shown in FIG. 6B, the actual foamability between the two samples were very similar (about 300%).

ii) Foam Stability

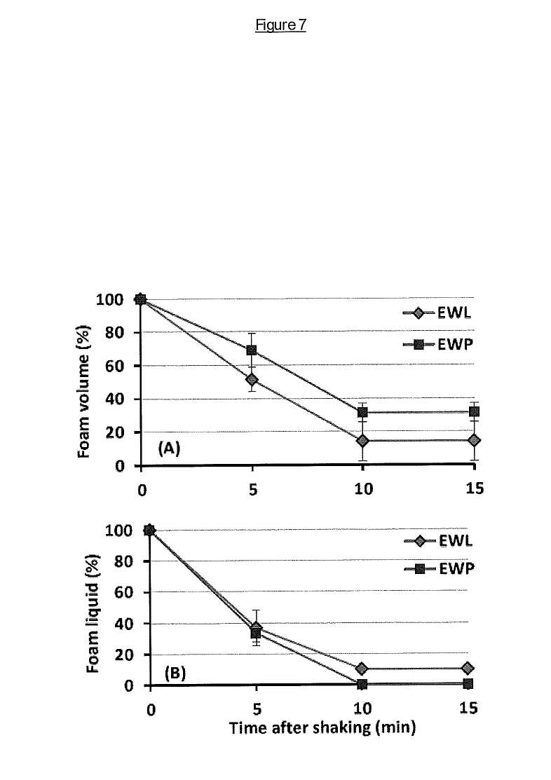

As shown in FIG. 7, booth the EWP and EWL were very unstable, both in terms of foam volume and foam liquid stability.

### Example 5: Effect of Sucrose/Protein with Gas Sparging

### Methodology:

The addition of different concentrations of sucrose and protein was tested. In order to adapt the concentration of protein, EWP was added to an EWP solution as necessary.

### Results and Discussion:

i) Foamability

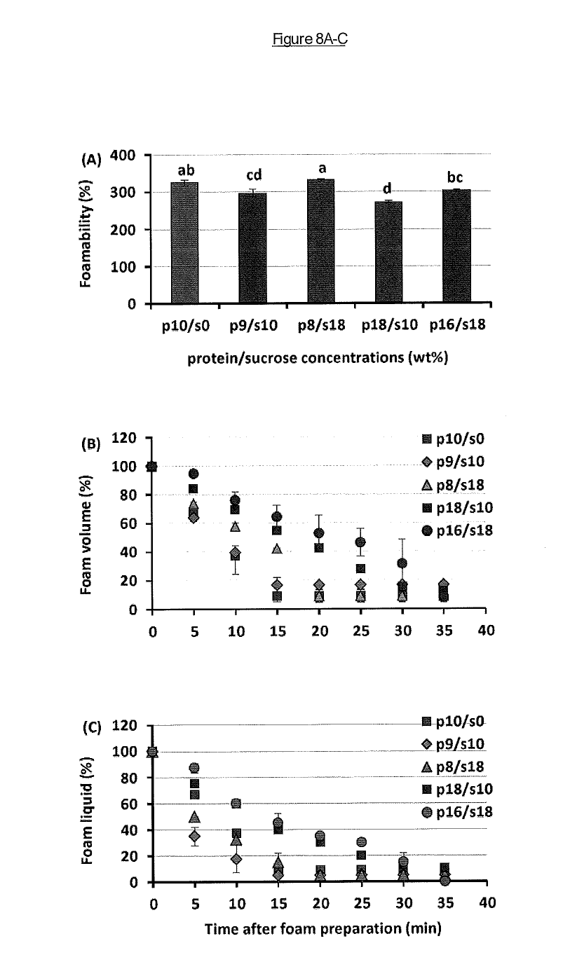

As shown in FIG. 8a, foamability was not overly affected by sugar and/or protein. This is interesting, as foamability was severely affected by sugar in the whipping method (not shown). In the gas sparging method, sugar advantageously improves the overall texture of the foam to be more smooth and creamy. It also is beneficial for flavouring.

ii) Foam Stability

As shown in FIGS. 8b and 8c, foam stability was affected reduced when sucrose concentration was increased. However, if protein concentration was increased concurrently, foam stability was restored slightly. However, in all cases, foam stability was depleted to almost 0% within 30 minutes.

### Example 6: Effect of Thickeners with Gas Sparging

### Methodology:

Different types, concentrations and combinations of thickeners (xanthan gum—XG, guar gum—GG and gum Arabic—GA) were trialed as shown in Table 2 (Table 4.2). The amounts were dissolved into EWP solution (10% protein) before testing foam characteristics using the gas sparging method.

| | XG | GG | | EWP | Total | |
|---|---|---|---|---|---|---|
| | (w/w | (w/w | GA | solution^{a} | volume | Protein |
| Sample code | %) | %) | (w/w %) | (g) | (ml) | (%) |
| Control | 0 | 0 | 0 | 100 | 100 | 10 |
| X2/G2/GA | 0.02 | 0.02 | 2 | 99 | 100 | 9.9 |
| X2/G4/GA | 0.02 | 0.04 | 2 | 99 | 100 | 9.9 |
| X4/G2/GA | 0.04 | 0.02 | 2 | 99 | 100 | 9.9 |
| X4/G4/GA | 0.04 | 0.04 | 2 | 99 | 100 | 9.9 |

^{a}EWP solution containing 10 w/v % protein
Abbreviations, XG, GG and GA, represent xanthan gum, guar gum and gum arabic, respectively

Altalhi., 2013—unpublished embargoed Masters thesis

### Results and Discussion:

i) Foamability

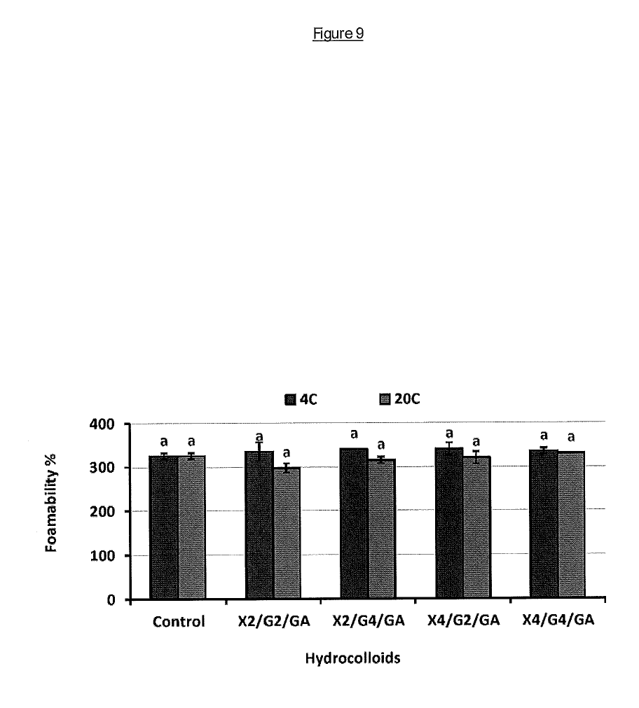

As shown in FIG. 9, foamability was not overly affected by adding different amounts/types/combinations of thickeners compared to the control, regardless of whether the temperature of the gas sparged EWP solution was at 20° C. or 4° C. The thickeners did have a good effect, however, on overall creaminess of the foams (not shown).

ii) Foam Stability

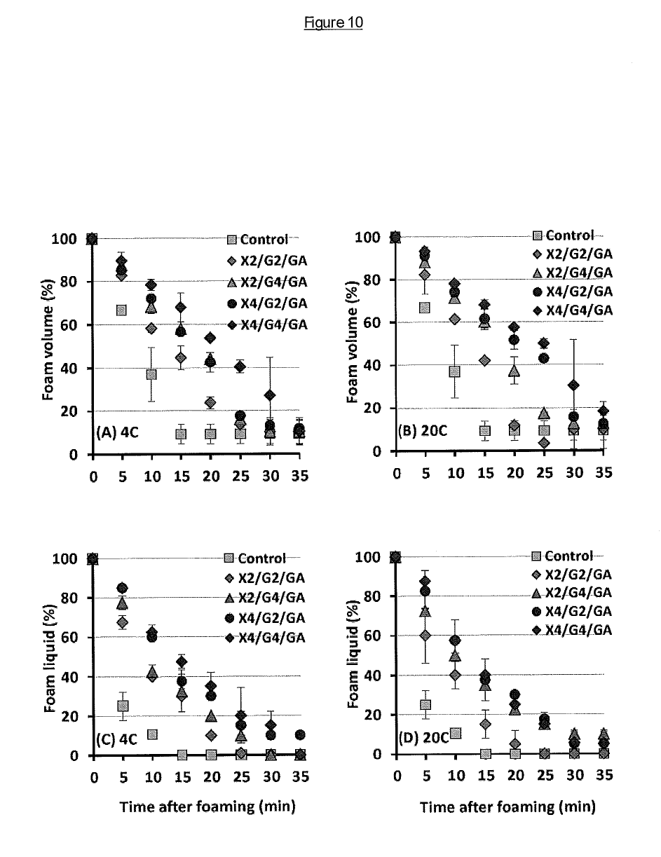

As shown in FIG. 10, the thickeners did have a positive effect on foam stability, particularly in the short term. However, by the 30 minute time point all samples showed close to baseline (0%) foam volume and foam liquid.

### Example 7; Effect of Heat Treatment of EWL

### Methodology:

Pre-heating the EWL was tested to determine the effect on foam characteristics. Samples were heated to various temperatures shown in the results, and then once reached, the samples were placed in a ice water bath to cool down.

### Results and Discussion:

i) Protein Denaturation

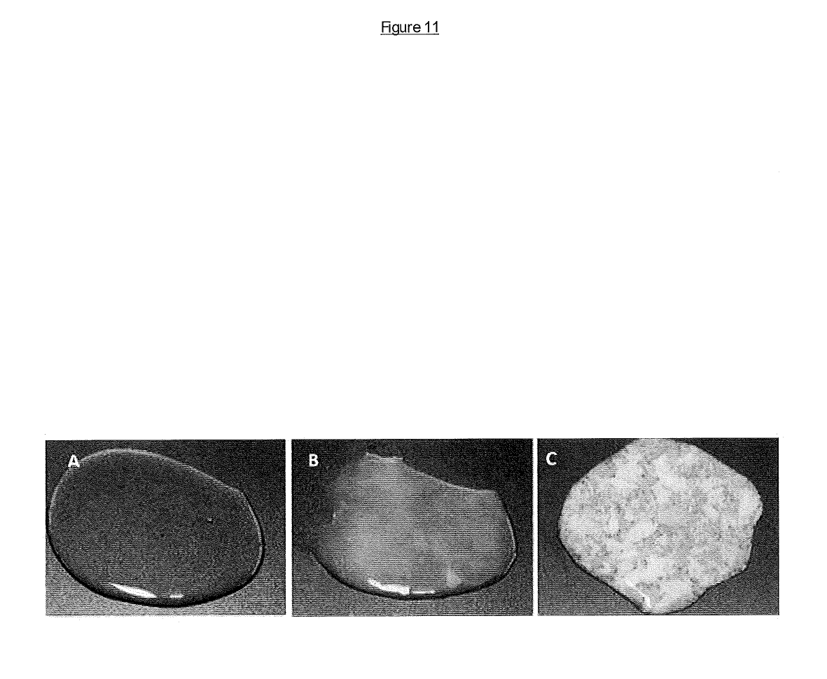

As shown in FIG. 11, protein denaturation began to occur as shown by the relative turbidly of the samples.

ii) Foamability

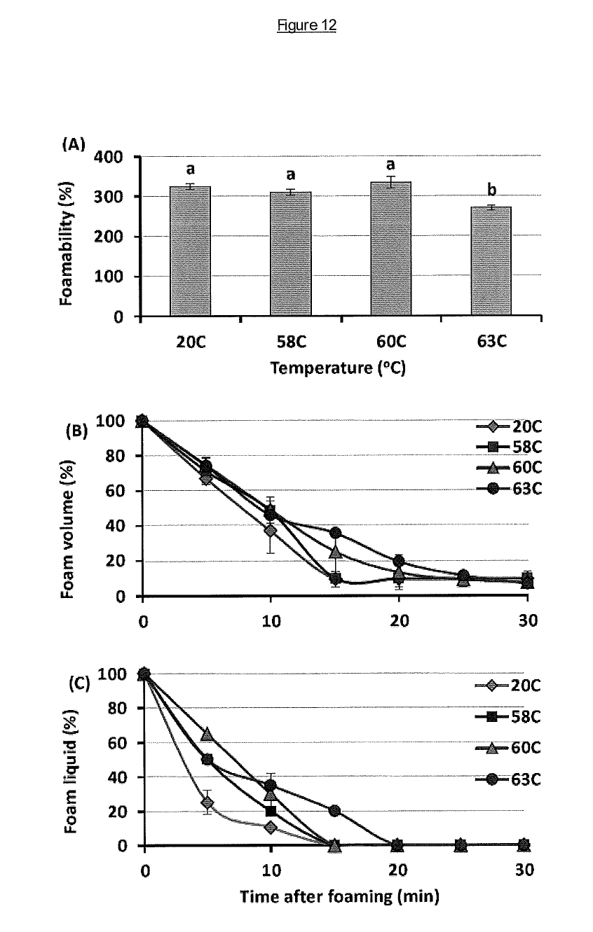

As shown in FIG. 12, foamability was not affected by the pre-heat temperature.

iii) Foam Stability

As also shown FIG. 12, foam stability remained poor and dropped to a baseline of close to 0% within about 30 minutes in all samples.

### Example 8: Effect of Heat Treatment of Composition Containing EWL and Thickener(s)

### Methodology:

As shown in Table 3 below, EWL was mixed with a number of ingredients as shown below, most notably the addition of a combination of thickeners. It should be appreciated that the protein concentration will have reduced slightly below 10% as a result of adding these ingredients. After mixing, the sample was split up into aliquots, and heat treated at 20, 58, 60 and 63° C. before applying the gas sparging method.

| Ingredients | Percentage (w/v %) |
|---|---|
| Sugar | 20 |
| Citric acid | 0.05 |
| Xanthan gum | 0.04 |
| Guar gum | 0.04 |
| Locust bean gum | 0.04 |
| Gum arabic | 2 |

Altalhi., 2013—unpublished embargoed Masters thesis

### Results and Discussion:

i) Protein Denaturation

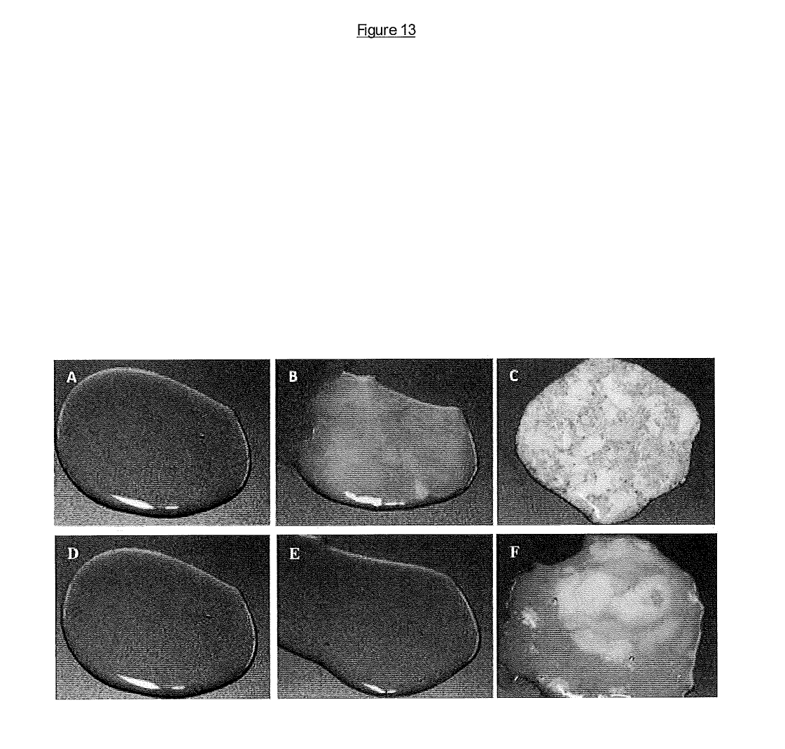

As shown in FIG. 13, the presence of thickeners dramatically improved stability of the protein, and reduced protein denaturation at the upper temperatures.

ii) Foamability

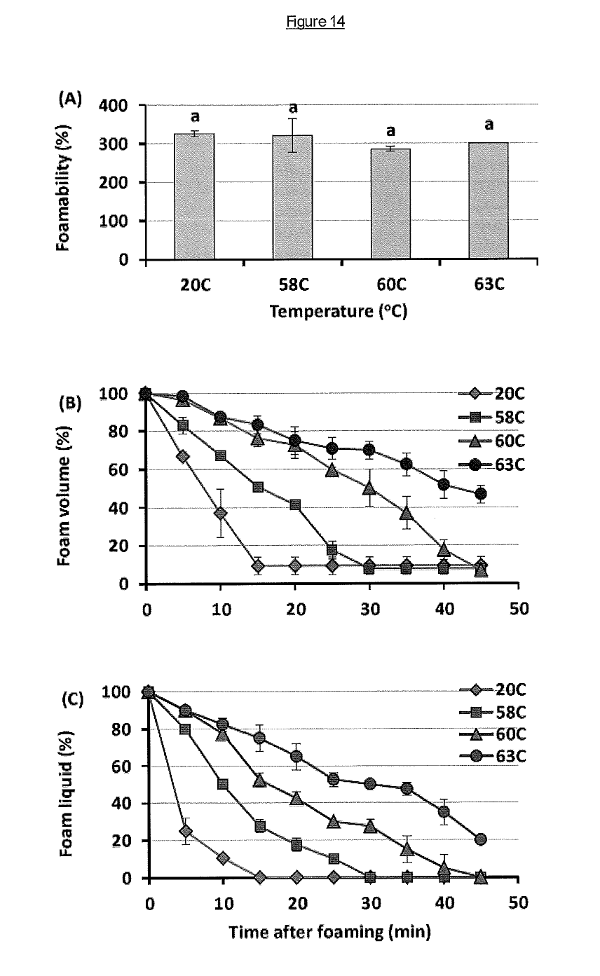

As shown in FIG. 14, the foamability was not overly affected, and remained at about 300% in all samples.

iii) Foam Stability

As shown also in FIG. 14, the foam stability was remarkably improved as the pre-heat step was raised to higher temperatures. Both foam volume and foam liquid improved substantially. At the 30 minute time point, foam volume remained at about 70%, and foam liquid remained at about 50%. This was a substantial and unexpected improvement compared to other trials, which all showed close to 0% at this 30 minute time point. Even at 45 minutes (at the end of the experiment), foam volume and foam liquid showed beneficial results.

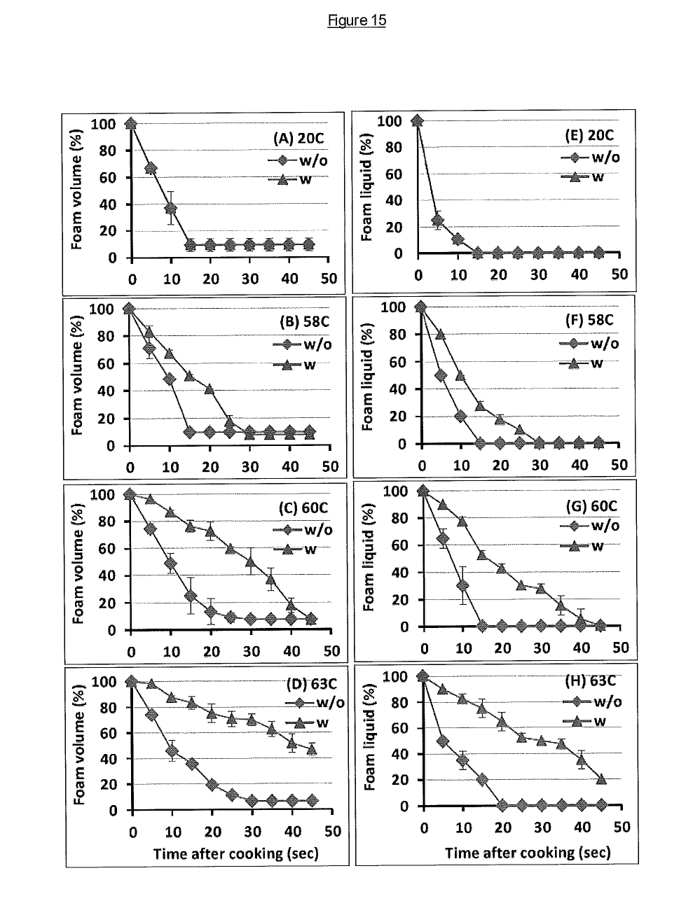

FIG. 15 also illustrates the same point comparing each pre-heat condition with or without added thickeners. Where no thickeners are present, the pre-heat step has poor outcomes. As soon as the combination is made (thickener+pre-heat), a synergistic effect is observed. One can expect that in the case of using HHP in combination with pre-heat, albeit at lower temperatures (as can be used for pasteurization), the same beneficial results would be observed.

### Example 9: Effect of Subsequent Cooking of Foams

### Methodology:

To exemplify a further advantage of the invention, microwave cooking was trialed on the egg white foams.

Egg white foams were produced using the whipped cream dispenser as described previously. Foams produced were cooked immediately using a microwave oven (Menumaster commercial microwave, RMS510D, UK) with 1000 watt and 25.5 litre capacity. Egg white solutions used for this experiment were EWL and EWP solutions. The initial volume of egg white solutions used for the foam preparation with the whipped cream dispenser was 100 g and the shaking time applied was 20 times. After shaking, foam was dispensed into a glass beaker (700 ml) and then cooked in the microwave oven for different cooking times ranging from 5 s to 40 s to determine its influence on the foam properties.

Various combinations of thickeners (XG, GG, LBG, GA) were added to the EWL/EWP, as shown in Table 4 below. Sample 1 can be seen as the control sample without any thickener added.

In some trials, discussed below, the compositions were pre-heat treated to determine the effect on the subsequent cooked foams.

| Sample | | Ingredient | EWL | Total | Ingredient | Protein |
|---|---|---|---|---|---|---|
| code | Ingredients | (g) | (g) | (g) | (%) | (%) |
| 1 | Citric acid | 0.05 | | | 0.04 | |
| | Sugar | 20 | 100 | 120.05 | 16.7 | 8.33 |
| | Citric acid | 0.05 | | | 0.04 | |
| 2 | Xanthan | 0.04 | 99 | 99.16 | 0.03 | 9.98 |
| | gum | | | | | |
| | Guar gum | 0.04 | | | 0.03 | |
| 3 | Xanthan | 0.04 | | | 0.03 | |
| | gum | | | | | |
| | Locust Bean | 0.04 | | | 0.03 | |
| | gum | | | | | |
| 4 | Sugar | 20 | 99 | 119 | 16.8 | 8.32 |
| | Xanthan | 0.04 | | | 0.03 | |
| | gum | | | | | |
| | Guar gum | 0.04 | | | 0.03 | |
| 5 | Sugar | 20 | 99 | 119 | 16.8 | 8.32 |
| | Xanthan | 0.04 | | | 0.03 | |
| | gum | | | | | |
| | Locust bean | 0.04 | | | 0.03 | |
| | gum | | | | | |
| 6 | Sugar | 20 | 99 | 119 | 16.5 | 8.32 |
| | Citric acid | 0.05 | | | 0.04 | |
| | Gum arabic | 2 | | | 1.65 | |
| 7 | Sugar | 20 | 100 | 122.17 | 16.4 | 8.19 |
| | Citric acid | 0.05 | | | 0.04 | |
| | Xanthan | 0.04 | | | 0.03 | |
| | gum | | | | | |
| | Guar gum | 0.04 | | | 0.03 | |
| | Locust bean | 0.04 | | | 0.03 | |
| | Gum | | | | | |
| | Gum arabic | 2 | | | 1.64 | |

Altalhi., 2013—unpublished embargoed Masters thesis

### Results and Discussion:

i) Foamability (without Pre-Heating)

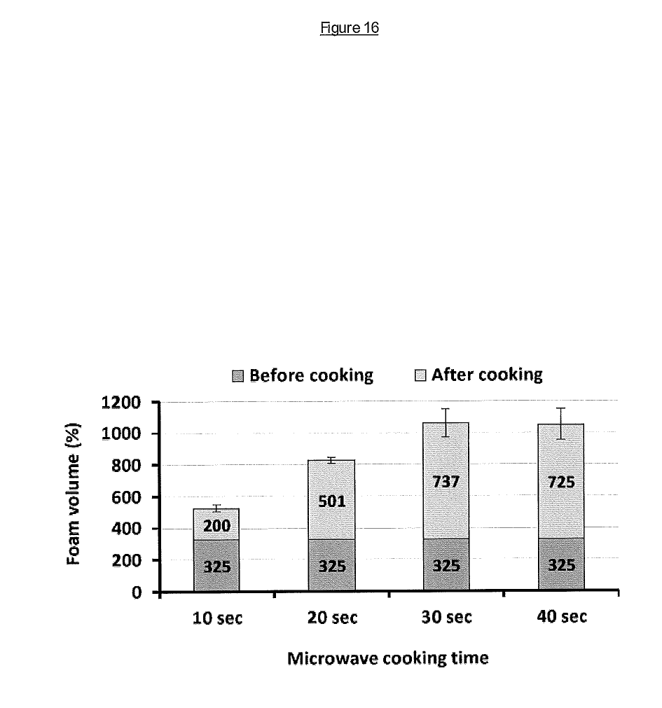

As shown in FIG. 16, microwaving increased the foam volume dramatically, particularly for samples microwaved for between 20-40 seconds.

ii) Foam Stability (without Pre-Heating)

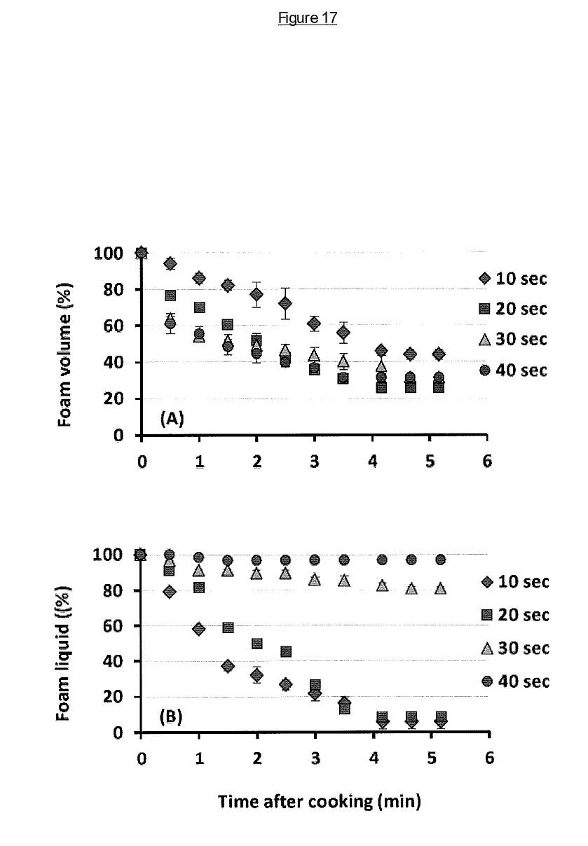

As shown in FIG. 17, the cooked products showed about 50% loss of foam volume within 5 minutes. Foam liquid dropped sharply to about 0% in samples only microwaved for 10-20 seconds. Yet, in samples microwaved for 30-40 seconds, foam liquid stayed at virtually 100% without any sign of reduction.

iii) Foamability (with Pre-Heating)

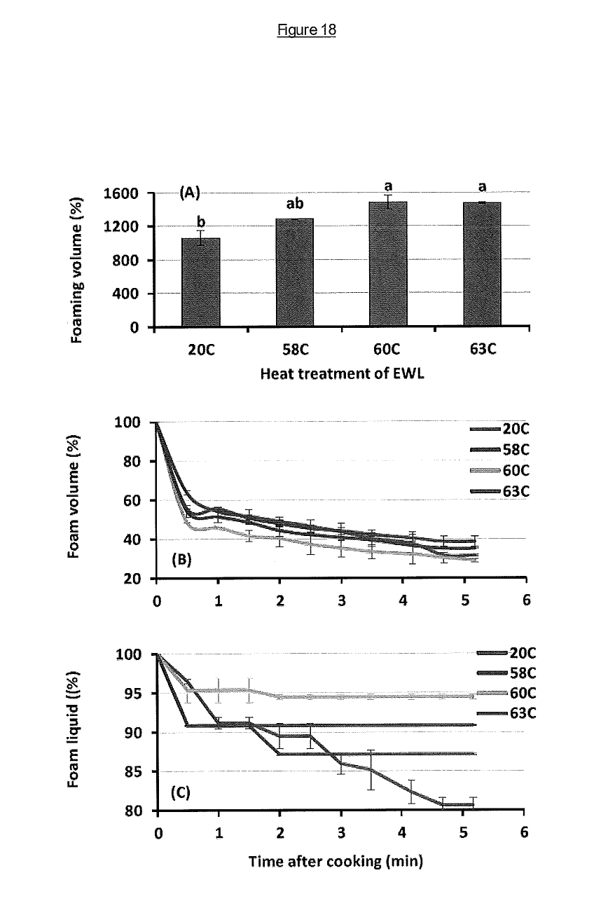

As shown in FIG. 18 (FIG. 5.11), foam volume was considerably higher for the EWL that was pre-heat treated at 58, 60 and 63° C., even more-so than seen without pre-heating.

iv) Foam Stability (with Pre-Heating)

As also shown in FIG. 18, foam volume was roughly consistent regardless of the pre-heat temperature. Yet, it begins to plateau out by about 5 minutes, where foam volume is at about 40%. However, remembering that the initial foaming volume had dramatically increased by at least 3-fold, a 60% reduction still represents over 100% relative foamability at this six minute time point. Foam liquid was also shown to be retained at about 90% or above with pre-heating above 58° C., and plateaued at this level at 5 minutes. The sample pre-heated to 20° C. only showed 80% foam liquid at 5 minutes.

### Example 10 Foam Appearances

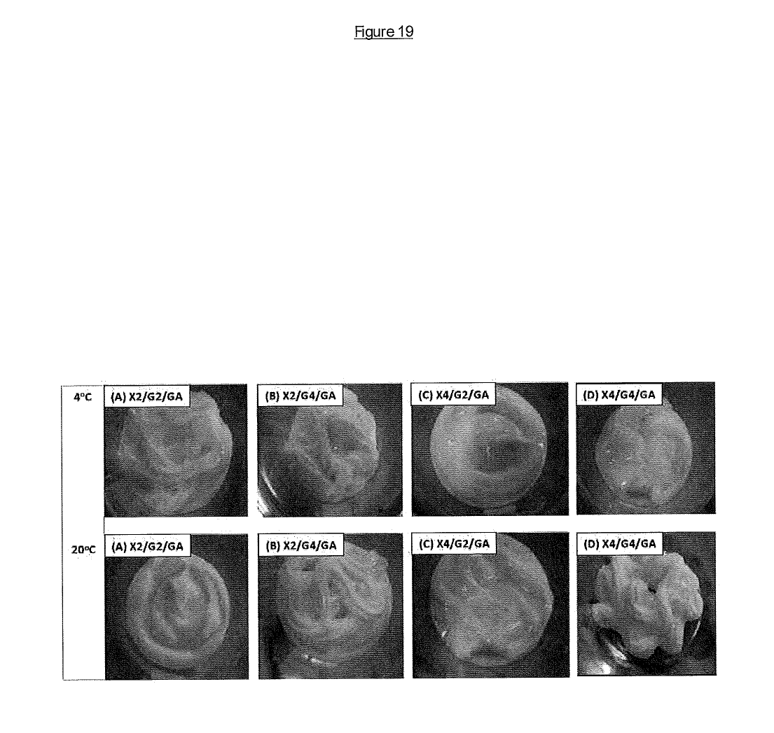

FIG. 19 illustrates the appearance of some foams according to the present invention that are uncooked. The appearance may be altered based on amounts and types of thickeners used, and pre-heat temperatures applied.

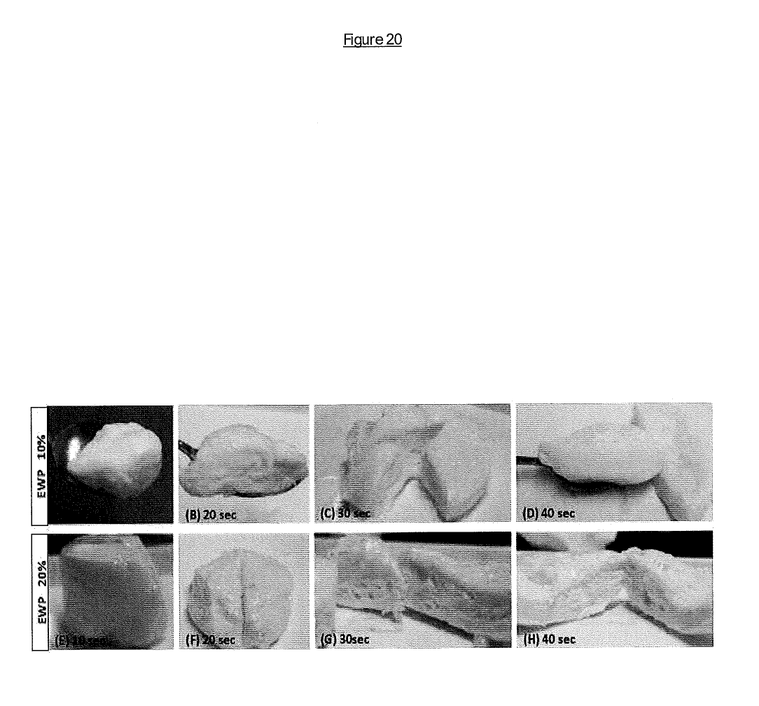

FIG. 20 illustrates the appearance of some foams according to the present invention that are subsequently cooked by microwave.

The entire disclosures of all applications, patents and publications cited above and below, if any, are herein incorporated by reference.

Reference to any prior art in this specification is not, and should not be taken as, an acknowledgement or any form of suggestion that that prior art forms part of the common general knowledge in the field of endeavour in any country in the world.

The invention may also be said broadly to consist in the parts, elements and features referred to or indicated in the specification of the application, individually or collectively, in any or all combinations of two or more of said parts, elements or features.

Where in the foregoing description reference has been made to integers or components having known equivalents thereof, those integers are herein incorporated as if Individually set forth.

It should be noted that various changes and modifications to the presently preferred embodiments described herein will be apparent to those skilled in the art. Such changes and modifications may be made without departing from the spirit and scope of the invention and without diminishing its attendant advantages, it is therefore intended that such changes and modifications be included within the present invention.

Aspects of the present invention have been described by way of example only and it should be appreciated that modifications and additions may be made thereto without departing from the scope thereof as defined in the appended claims.

1. A composition when used for the subsequent preparation of an egg white foam, wherein the composition includes
a) an amount of an egg white material;
b) at least one thickener, wherein the amount of the at least one thickener is at least about 2.0% w/w in the composition;
and wherein the composition has been heat treated at or above about 40° C. prior to preparing the egg white foam.

2. The composition of claim 1, wherein the the at least one thickener is alginin, guar gum, locust bean gum, gum arabic, xanthan gum, or any combination or derivative thereof.

3. The composition of claim 1, wherein the composition has been heat-treated between 15° C. to 75° C.

4. The composition of claim 1, wherein the composition has been heat-treated between 50° C. to 70° C.

5. The composition of claim 1, wherein the composition has been heat-treated at about 63° C.

6. The composition of claim 1, wherein the composition has been heat-treated for between 10 seconds to 10 minutes.

7. The composition of claim 1, wherein the composition has been heat-treated for about 2 minutes.

8. (canceled)

9. The composition of claim 1, wherein the composition includes between 5% w/w to 20% w/w protein.

10. (canceled)

11. The composition of claim 1, wherein the composition includes sugar in the range of 1-30% w/v.

12. The composition of claim 1, wherein the composition has a pH of between 6-10.

13. (canceled)

14. A food product including an egg white foam prepared with a composition according to claim 1.

15. An egg white foam comprising
a) an amount of an egg white material,
b) at least one thickener, wherein the amount of the at least one thickener is at least about 2% w/w of the egg white foam, and
wherein the amount of the egg white material and the at least one thickener have been heat treated together above at least 40° C. prior to forming the egg white foam.

16. A method of preparing a composition according to claim 1 or an egg white foam, wherein the method includes the step of aerating the composition to produce the egg white foam.

17. The method of claim 16, wherein the step of aerating is performed via gas sparging.

18. The method of claim 16, wherein the egg white foam is not cooked.

19. (canceled)

20. The method of claim 16, wherein the egg white foam is partially or fully cooked.

21. The method of claim 20, wherein the method of cooking is microwaving, frying, baking, deep-frying, extrusion cooking, and/or poaching.

22. A method for preparing a food product selected from the group consisting of an omelette, pavlova, meringue, tofu replacement, a thickshake, a dairy free mousse, a yogurt style snack, and a sorbet.

23. A method of preparing a cooked food product comprising an egg white foam as an ingredient, which comprises
a) inserting an amount of an egg white material into a substantially sealable container;
b) pressurizing the container by incorporating a gas;
c) releasing at least a portion of the egg white material through an aperture in the container to produce the egg white foam; and
d) cooking or partially cooking the egg white foam.

24-28. (canceled)

29. A device for producing an egg white foam, which comprises an aerosol container having an aperture, and a composition according to claim 1, whereby when purged through the aperature, the egg white foam is produced.
